(19) United States
(12) Patent Application Publication
(10) Pub. No.: US 2010/0182146 A1
(43) Pub. Date: Jul. 22, 2010

(54) DEVICE FOR DETECTING EXPLOSIVES BY RADIOFREQUENCY

(76) Inventor: Benjamin Cebrian Romo, Boadilla del Monte (Madrid) (ES)

Correspondence Address: DENNISON, SCHULTZ & MACDONALD, 1727 KING STREET, SUITE 105, ALEXANDRIA, VA, 22314, US

(21) Appl. No.: 12/665,369

(22) PCT Filed: Jun. 27, 2008
(86) PCT No.: PCT/ES08/00460

§ 371 Date: Dec. 18, 2009

(30) Foreign Application Priority Data
Jun. 27, 2007 (ES) U200701617

(51) Int. Cl. G08B 21/00

(52) U.S. Cl. 340/540

(57) ABSTRACT

Device for detecting explosives by radio frequency the invention relates to an arrangement specially conceived and designed to allow detecting both the presence in a specific place and tracking the trajectory followed by an explosive, for the purposes of generating, if appropriate, alarm and warning signals warning of the presence of explosives in a place where it should not be. The arrangement is based on the integration of RFID tags into each one of the explosive cartridges or into the corresponding detonators, together with detectors formed as emitter-receiver devices with a certain radius of action, through whose antennae signals are sent generating responses on the part of the RFID tags which allow carrying out a control of the explosives, and/or generating alarms, as appropriate. The RFID tags can alternatively be connected to the sides of the container box, or even be incorporated into the mass for preparing the explosive product.

### OBJECT OF THE INVENTION

The present invention relates to a device for detecting explosives by radiofrequency providing essential novel features and considerable advantages with respect to similar means known in the current state of the art and intended for the same purposes.

The invention more specifically proposes developing a device consisting of an assembly in which radiofrequency (RF) emission means intervene, which means are associated to a work machine in field operations or where applicable associated to portable search means and electronic tag means (known in the state of the art as an RFID tag) acting as a transponder element when it receives the RF energy sent from said emitter.

The field of application of the invention is obviously comprised within the industrial sector dedicated to the manufacture and installation of detectors in general, with special application in the case of explosives.

### BACKGROUND AND SUMMARY OF THE INVENTION

The fact that industrial explosives are used in blasting and leveling operations, which are a potential risk for the safety of the operators of perforating, cutting (jack hammer type), excavating (diggers and excavators), transport (trucks) and grinding (crushers, mills) machines in civil works and in mining, is generally known by all.

Statistically, there is an amount of explosives, sometimes of the order of several kilos, which are not detonated when blasting. Said explosives are usually placed in a pile, camouflaged among the dust, mud and stone fragments. When any of the machines of the type previously mentioned carry out a job near the place in which there are explosive remains, there is a high probability that a potentially fatal accident will occur.

It is to that end, for the purpose of preventing these types of accidents, that the design and development of a device has been proposed as a main objective of the invention which allows effectively and safely detecting and identifying an explosive in the place in which it could have been concealed, therefore preventing the occurrence of any accident.

The device of the invention is essentially based on integrating in the explosive cartridges and detonators, by means of an operation performed in factory, a microchip of the type which is known as an RFID tag, i.e., a read-only type microchip which, associated to an antenna, forms a transponder assembly capable of generating a response signal when it is reached by an RF signal emitted from emission means which can normally even be several meters away and which does not necessarily have to be “seen” with the reader device. This microchip does not need an internal power supply but rather when it is reached by an RF signal, the generated current is sufficient for supplying power to the microchip and generating the corresponding response signal.

The work device or machine in turn incorporates emission means with an antenna located in a position such that it occupies a position as close as possible to the work area of the tools which at any given time could access the explosive, therefore ensuring the success of the detection. Acoustic and/or light warning signals can be inserted in the console of the machine operator such that he or she can be appropriately advised when the presence of explosives in the work area is detected.

As will be understood, the incorporation of this type of RFID tag in the explosive cartridges does not only allow the possible detection of the unexploded cartridges and detonators, but is also an effective means of controlling the storage, transport and delivery, where applicable even the identification and origin, of the cartridge which may have gone unexploded in a blasting.

In a version that is alternative and complementary to applying the device of the invention to the case of the previously mentioned machines for works, a portable, manually-operated implementation form can be provided which is especially suitable to be used in detecting explosives in tunnel blasting or small civil works blasting, in which the RF emission device is incorporated in a manually handled element, arranged close to the end of said element which is moved near the ground and which when detecting a possible explosive likewise causes the generation of a warning signal which is observed acoustically or visually by the carrier of the device.

As will be understood, a device as that proposed by the invention allows easily, economically and above all effectively solving the problem associated to industrial explosives which may have gone unexploded for any reason.

### BRIEF DESCRIPTION OF THE DRAWINGS

These and other features and advantages of the invention will be more clearly shown from the following detailed description of a preferred embodiment thereof, only given by way of an illustrative and in no case limiting example, taken along with the attached drawings in which:

FIG. 1 is a schematic depiction of a first embodiment of the invention with the device made according to a preferred example in collaboration with an excavating machine.

FIG. 2 shows a schematic depiction of a second embodiment of the invention in which the device for detecting explosives is a portable, manually-operated device.

### DESCRIPTION OF A PREFERRED EMBODIMENT

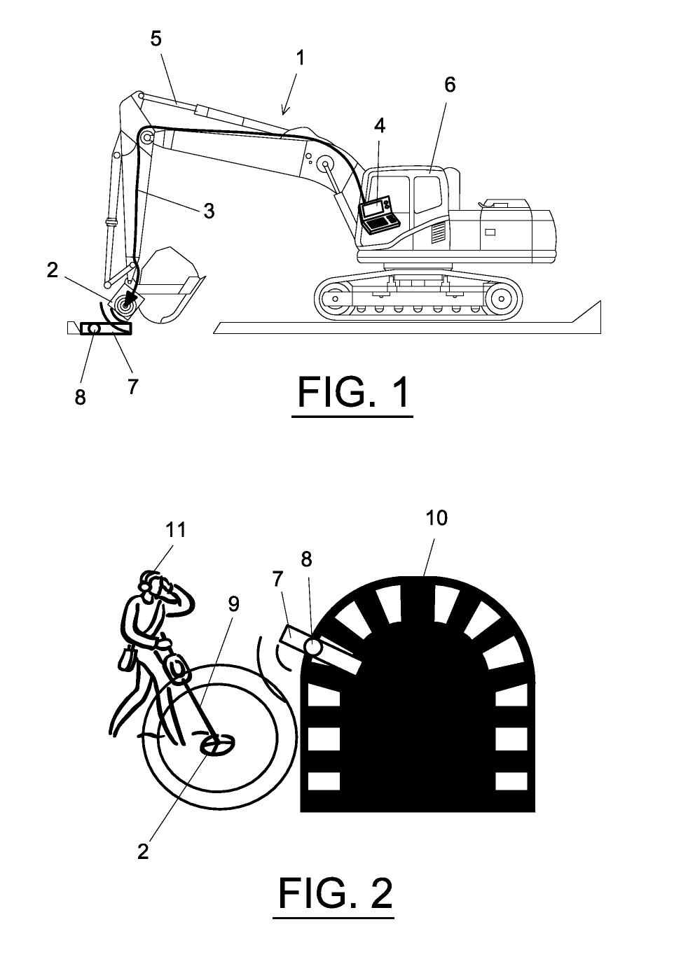

As has been mentioned above, the detailed description of the preferred embodiment of the invention will be carried out below with the aid of the attached drawings, through which the same reference numbers are used to designate equal or similar parts. Thus firstly in accordance with the depiction which appears in FIG. 1, a preferred application case of the invention can be seen associated to an excavating machine generally indicated with reference number 1, and carrying one of the essential elements forming part of the device of the invention, namely the emission means 2 with its corresponding antenna in charge of generating an RF signal and emitting it for the purpose of thoroughly scanning the space surrounding the position which it occupies at all times as the machine operates. These emission means 2 are electronically connected through a cable 3 extending along the arm 5 of the machine, duly protected, to the console 4 located inside the cabin 6 of the machine 1 and located in a position easily accessible and visible for the machine operator. This console 4, where applicable, will emit the warning and alarm signals which can be observed by the machine operator or driver when there is a potential risk situation due to the detection of any unexploded detonator or cartridge.

Furthermore, as a second part of the necessary assembly so that the device of the invention can successfully operate, each explosive cartridge or detonator, one of which is depicted in the figure and has been indicated with reference number 7, in turn incorporates electronic tag means of the type which has been defined above. This electronic tag, indicated with reference number 8, is integral with the cartridge and detonator and is incorporated therein in factory during the production process. Thus when a cartridge or detonator 7 has not exploded and a machine, such as the excavator 1, carrying the emission means 2, approaches the place in which it has been deposited and concealed when carrying out different jobs, said cartridge 7 causes the interaction between the RF signal emitted permanently by the antenna of the element 2 and the radiofrequency tag incorporated in the cartridge, a signal being generated by the latter which when detected by the antenna of the element 2 itself, causes the generation of the visible and/or audible alarm signals through the console 4, warning the operator at the appropriate time that there is a explosive cartridge and that the necessary measurements must be taken to locate and remove it.

According to that depicted in FIG. 1, the chosen embodiment is that of an excavating machine with the emission means assembled in the excavator tool or bucket in any place protected from blows and impacts against rocks, such as inside a hinge of the bucket or next to the hydraulic sleeves for example. Now according to that previously mentioned, the device can be equally applied to a wide variety of machines such that the location will be that which is considered most suitable in each case, such as for example:
in the case of the excavator (already explained), inside a hinge of the bucket or next to the hydraulic sleeves or the hydraulic intersections;
in the case of a truck, the most suitable place will probably be under the bumper, next to the wheels which can pass over any remains, and/or under the load;
when to the machine is a perforator, the location can be next to the stabilizer of the sinker bars, such that it captures the signals of the explosives next to the perforation mouth;
finally in the case of a bulldozer the suitable location can be next to the swivel joint of the digger bucket.

In all applications, the tag 8 associated to the cartridge 7 will be of the type that can not be heated to a temperature that could compromise the safety of the explosive cartridge. The tag will comply with the legal guidelines in force: passive and inert.

FIG. 2 of the drawings shows a schematic view depicting an embodiment alternative to that described, which is especially indicated for the case of tunnel blasting or small civil works blasting. It is a portable embodiment, manually handled by an operator, to which end the emission means 2 are now incorporated at the lower end of a longitudinal element 9 in the form of an elongated bar which can be carried manually, as has been said, by an operator. A possible cartridge 7 which may have remained in a civil works construction 10 will be seen within the operating range of the emitter 2 when it is moved though the area in which the cartridge is located, such that the coupling with the tag 8 will generate the emission of the signal, which captured by the antenna 2, will generate an audible signal through speaker or headphone means 11 carried by the operator. It is therefore a simplified, but equally effective and safe version of the first embodiment.

It is not considered necessary to extend this description so that a person skilled in the art can understand its scope and the advantages derived therefrom, as well as carry it out to practice.

In spite of the foregoing it must be understood that the description made only refers to a preferred embodiment and therefore it is possible to make multiple, equally protected variations which can affect the features of the elements and the types of electronic devices used, the shape, size or even materials for manufacturing the different elements, without departing from the scope of the invention.

1. A device for detecting explosives by radiofrequency intended to detect unexploded cartridges during blasting, concealed in work areas and therefore representing certain danger both for the people who handle the machines for carrying out the work and for the machines themselves, characterized in that it comprises: emission means (2) with an antenna for emitting an RF signal incorporated in any member of the machine protected against blows and impact with rocks or other materials from the work, preferably in a location near the position in which the work tool performs its task, and electrically connected by means of a cable (5) to a console (4) installed in the operator's cabin (6) and which can have acoustic and/or luminous warning signals, such as an alarm, for the machine operator, and electronic radiofrequency identification tag (RFID tag) means (8) incorporated in the cartridge and detonator, integral therewith which, when it is reached by the signal permanently emitted by the emitter (2), it behaves as a transponder generating a signal captured by the antenna (2) itself and based on which the alarm signals are generated for the operator through the console (4).

2. The device for detecting explosives by radiofrequency according to claim 1, characterized in that in a portable version, the emission antenna (2) is incorporated in the lower end of a longitudinal element (9) in the form of an elongated bar which can be handled manually by an operator through the investigated area, and which upon detection of a possible explosive cartridge (7) through its incorporated electronic tag (8), generates a signal which can be heard by the operator through a set of headphones or speakers (11).
